(19) United States
(12) Patent Application Publication
(10) Pub. No.: US 2002/0141002 A1
(43) Pub. Date: Oct. 3, 2002

(54) Image pickup apparatus

(75) Inventors: Manji Takano, Amagasaki-Shi (JP); Hiroyuki Okada, Izumi-Shi (JP); Tsutomu Honda, Sakai-Shi (JP); Junichi Tanii, Izumi-Shi (JP); Yasuaki Serita, Sakai-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/107,909

(22) Filed: Mar. 27, 2002

(30) Foreign Application Priority Data
Mar. 28, 2001 (JP) 2001-091861
Feb. 14, 2002 (JP) 2002-037404

(51) Int. Cl. H04N 1/46

(52) U.S. Cl. 358/513

(57) ABSTRACT

An image pickup apparatus is provided with a light sensing unit including a first light sensor including a plurality of light sensing elements provided at specified positions and a second light sensor provided adjacent to the first light sensor and including a group of light sensing elements other than those of the first light sensor; an exposure period setter for setting a first exposure period, and a second and a third exposure periods obtained by dividing the first exposure period; an image generator for generating a first image signal from electric charges accumulated in the respective light sensing elements during the first exposure period in the first light sensor, generating a second image signal from electronic charges accumulated in the respective light sensing elements during the second exposure period in the second light sensor, and generating a third image signal from electric charges accumulated in the respective light sensing elements during the third exposure period in the second light sensor; and an image combining device for combining the first, second and third image signals to generate an image signal of a subject. An image having a good image quality can be obtained by extending a dynamic range.

This application is based on patent application Nos. 2001-91861 and 2002-37404 filed in Japan, the contents of which are hereby incorporated by references.

### BACKGROUND OF THE INVENTION

This invention relates to an image pickup apparatus for picking up an image of a subject using a solid-state image pickup device.

Instead of cameras using silver salt films, electronic cameras using solid-state image pickup devices such as CCD (Charge-Coupled Device) sensors have started to spread in recent years. A dynamic range of the CCD sensor used in the electronic cameras is narrower than that of the silver salt films and, accordingly, various ingenuities have been made to extend the dynamic range of the electronic cameras.

For example, a method for substantially extending the dynamic range by combining a plurality of images successively picked up while changing the sensitivity of the CCD sensor is known. According to this method, times at which the respective images are picked up differ, causing time delays among the images. This method is not suited to photographing moving subjects. Even if this method is applied to photograph still subjects, the electronic cameras have needed to be fixed on a fixing table such as a tripod to pick up images in order to eliminate the influence of a camera shake.

Further, in an electronic camera disclosed in Japanese Unexamined Patent Publication No. 779372, fields forming a sensing surface of a CCD sensor are divided into odd-numbered fields and even-numbered fields, and the sensitivities of image signals of the odd-numbered fields having a longer exposure period are increased while those of image signals of even-numbered fields having a shorter exposure period are decreased by differing the exposure periods between the odd-numbered fields and the even-numbered fields. In the case that the image signal of the odd-numbered field experiences white compression or saturation of electric charges of the CCDs, the image signal experiencing the white compression is interpolated using the image signals of the even-numbered fields adjacent to this odd-numbered field, whereby the dynamic range is seemingly extended.

However, since the image signal of low sensitivity is generated by merely shortening the exposure period in the above electronic camera, a signal-to-noise (S/N) ratio of the image signal is reduced. Thus, even if the image signal having experienced the white compression is interpolated using the image signal having a low S/N ratio, there is a limit in improving the image quality of the interpolated section, making it difficult to obtain good images.

In an image pickup apparatus disclosed in Japanese Unexamined Patent Publication No. 11-220659, image signals corresponding to a plurality of fields are read from CCDs during a one-field period and saved, and the saved image signals corresponding to a plurality of fields are read and added during reproduction to suppress the levels of the respective CCDs to or lower than saturation level, whereby the dynamic range is extended.

Further, in an image pickup apparatus disclosed in Japanese Unexamined Patent Publication No. 11-298801, image signals corresponding to a plurality of fields are read from CCDs during a one-field period or a one-frame period and saved, and the saved image signals corresponding to a plurality of fields are added during reproduction, whereby the dynamic range is extended while the levels of the respective CCDs are suppressed to or lower than saturation level.

Since the image signals of the respective fields photographed, strictly speaking, by the temporally delayed exposures even if they are made during the one-field period or one-frame period are added in these image pickup apparatuses, an obtained image is blurred and there is a limit in obtaining good images. Particularly in the case of photographing moving objects or in the case of performing photographing while holding an electronic camera by hand, an image blur becomes more conspicuous, degrading the quality of the image.

### SUMMARY OF THE INVENTION

It is an object of the present invention to provide an image pickup apparatus which is free from the problems residing in the prior art.

According to an aspect of the invention, an image pickup apparatus is provided with a light sensing unit which has a first light sensor and a second light sensor adjacent to the first light sensor and having a group of light sensing elements other than those of the first light sensor.

The image pickup apparatus is further provided with an exposure period setter for setting a first exposure period, and a second exposure period and a third exposure period, the second and third exposure periods being obtained by dividing the first exposure period; an image generator for generating a first image signal from electric charges accumulated in the respective light sensing elements during the first exposure period in the first light sensor, a second image signal from electronic charges accumulated in the respective light sensing elements during the second exposure period in the second light sensor, and a third image signal from electric charges accumulated in the respective light sensing elements during the third exposure period in the second light sensor; and an image combining device for combining the first, second and third image signals to generate an image signal of a subject.

According to another aspect of the invention, a method for picking up an image, comprises setting a first exposure period, and a second exposure period and a third exposure period, the second and third exposure periods being obtained by dividing the first exposure period; generating a first image signal obtained during the first exposure period in a first light sensor, a second image signal obtained during the second exposure period in a second light sensor provided adjacent to the first light sensor, and a third image signal obtained during the third exposure period in the second light sensor; and combining the first, second and third image signals to generate an image signal of a subject.

These and other objects, features and advantages of the present invention will become more apparent upon a reading of the following detailed description and accompanying drawings.

### BRIEF DESCRIPTION OF THE DRAWINGS

FIG. 1 is a block diagram showing a construction of a main part of an electronic camera according to an embodiment of the invention;

FIG. 2 is a diagram showing a construction of a CCD sensor shown in FIG. 1;

FIG. 3 is a timing chart showing operations of the CCD sensor and a timing generator shown in FIG. 1;

FIG. 4 is a diagram showing an adding operation by an adding device shown in FIG. 1;

FIG. 5 is a diagram showing an interpolating operation by a white compression correcting unit shown in FIG. 1;

FIG. 6 is a block diagram showing a construction of a main part of an electronic camera according to another embodiment of the invention;

FIG. 7 is a diagram showing a color array of a color filter shown in FIG. 6;

FIG. 8 is a diagram showing a construction of a CCD sensor shown in FIG. 6;

FIG. 9 is a diagram showing an interpolating operation by an image data interpolating device shown in FIG. 6;

FIG. 10 is a diagram showing an image data combining operation by an image data combining device shown in FIG. 6; and

FIG. 11 is a timing chart showing operations of the CCD sensor and a timing generator of the electronic camera shown in FIG. 6.

### DETAILED DESCRIPTION OF THE PREFERRED EMBODIMENTS OF THE PRESENT INVENTION

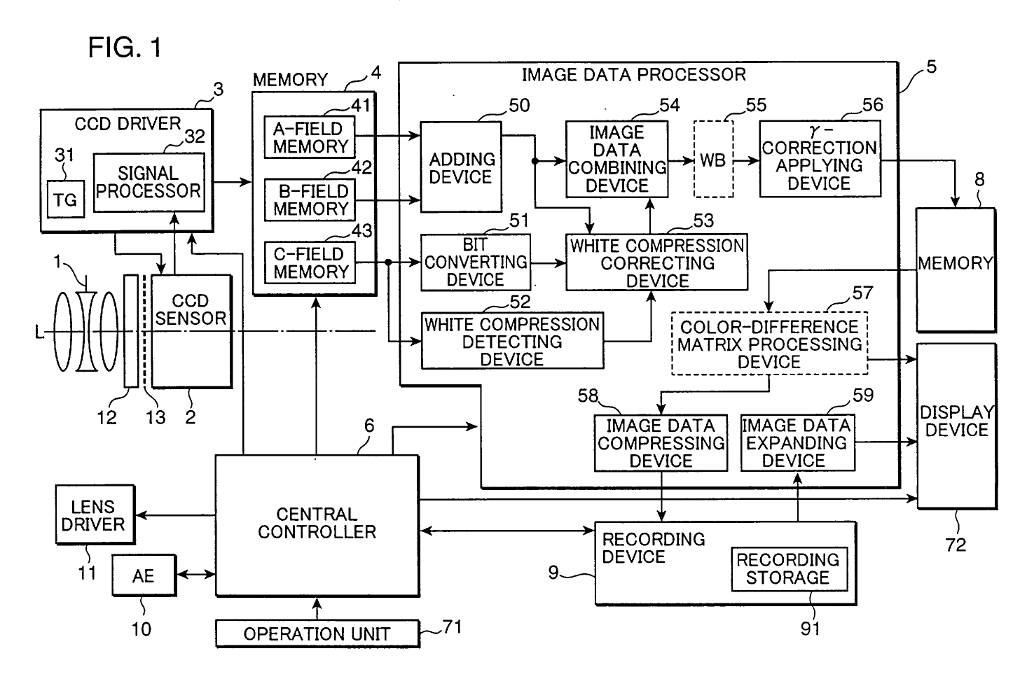

Referring to FIG. 1 showing a construction of a main part of an electronic camera according to an embodiment, an electronic camera is provided with a taking lens 1, a CCD sensor 2, a CCD driver 3, a memory 4, an image data processor 5, a central controller 6, an operation unit 71, a display device 72, a memory 8 and a recording device 9.

The taking lens 1 is for gathering a light from a subject and is, for example, an electric zoom lens. A lens driver 11 focuses and zooms the taking lens 1. The CCD sensor 2 is provided at a focusing position of beams of light on an optic axis L of the taking lens 1 via a mechanical shutter 12 for controlling an aperture and an exposure. Although not shown, an optical low-pass filter, an infrared cut-off filter, an ND filter for adjusting an amount of light, or the like is provided if necessary.

The CCD sensor 2 is constructed such that a multitude of light sensing elements PE_{i.j} (i=1 to M, j=1 to N) are arrayed in a matrix, lights from a subject are photoelectrically converted by the respective light sensing elements, and the converted electric charges are accumulated. The CCD sensor 2 is, for example, an interline-transfer type CCD sensor adopting an interlace reading system in which light sensing elements made of photodiodes are arrayed in a matrix.

The CCD driver 3 drives the CCD sensor 2 and includes a timing generator 31 and a signal processor 32.

The timing generator 31 outputs a control signal SC1 to be described later to the CCD sensor 2. The CCD sensor 2 performs a specified operation such as a release of residual electric charges in response to the control signal SC1, photoelectrically converts an incident light, and outputs the accumulated electric charges to the signal processor 32 as an image signal.

The signal processor 32 applies signal processings including a correlative double sampling and an analog-to-digital (A/D) conversion to the signals outputted from the CCD sensor 2, and outputs digitized image signals to the memory 4.

The memory 4 is adapted to temporarily save the image signals obtained by the CCD sensor 2 and includes three field memories 41 to 43. Out of the image data outputted from the signal processor 32, first image data EVEN1 of even-numbered lines to be described later are saved in an A-field memory 41; second image data EVEN2 of the even-numbered lines to be described later are saved in a B-field memory 42; and image data ODD0 of odd-numbered lines to be described later are saved in the C-field memory 43.

The image data processor 5 applies specified processings to the image signals saved in the memory 4, and includes an adding device 50, a bit converting device 51, a white compression detecting device 52, a white compression correcting device 53, an image data combining device 54, a γ-correction applying device 56, an image data compressing device 58 and an image data expanding device 59.

The adding device 50 adds the first image data EVEN1 of the even-numbered lines saved in the A-field memory 41 and the second image data EVEN2 of the even-numbered lines saved in the B-field memory 42, and the added image data are outputted to the white compression correcting device 53 and the image data combining device 54 as image data EVEN of the even-numbered lines.

The bit converting device 51 shifts the image data ODD0 of the odd-number line saved in the C-field memory 43 upward by one bit, and outputs the image data ODD0 of the odd-numbered lines whose bit number coincides with that of the image data EVEN of the even-numbered lines to the white compression correcting device 53.

The white compression detecting device 52 detects whether or not the values of the image data ODD0 of the odd-numbered lines saved in the C-field memory 43 are saturated to thereby detect a portion where the value is saturated as a white compression portion, and outputs the detection result to the white compression correcting device 53.

The white compression correcting device 53 outputs an image data obtained by interpolating the white compression portion using the image data EVEN of the even-numbered lines to the image combining device 54 as image data ODD of the odd-numbered lines in the case that the white compression detecting device 52 detects the white compression portion, whereas it outputs the image data ODD of the odd-numbered lines outputted from the bit converting device 51 as they are to the image combining device 54 in the case that the white compression detecting device 52 detects no white compression portion.

The image combining device 54 generates an image data of the entire screen from the inputted image data EVEN of the even-numbered lines and image data ODD of the odd-numbered lines and outputs the generated image data to the γ-correction applying device 56.

The γ-correction applying device 56 applies a specified γ-correction to the image data of the entire screen generated by the image data combining device 54, and saves the resulting data in the memory 8.

The image data compressing device 58 applies an image compression such as JPEG (joint photographic experts group) to store the image data of the entire screen saved in the memory 8 in a recording medium 91.

The image data expanding device 59 reads the compressed image data of the entire screen from the recording medium 91 and applies an image expansion thereto in order to display an image corresponding to this image data on the display device 72.

The central controller 6 outputs control signals to the respective parts of the camera, and controls the lens driver 11, the mechanism shutter 12, the CCD driver 3, the image data processor 5, the recording device 9, a light measuring device 10, etc. in accordance with signals from the operation unit 71 externally operated.

The operation unit 71 is comprised of a group of externally operable switches provided on the electronic camera, which switches include a power switch, a shutter start button, a mode changeover switch of, e.g., changing a recording mode to a reproducing mode and vice versa, a forwarding switch used at the time of reproducing images, a zoom switch, etc.

The display device 72 includes a liquid crystal display (LCD) or the like and displays various pieces of information.

The memory 8 is adapted to temporarily save the image data to which the γ-correction was applied by the γ-correction applying device 56, and the saved image data is outputted to the image data compressing device 58. Although not shown, related information including a date of photographing can be stored simultaneously with the image data as a header information in the recording medium 91 by the recording device 9.

The recording device 9 is formed of a memory card recorder or the like and records the compressed image data.

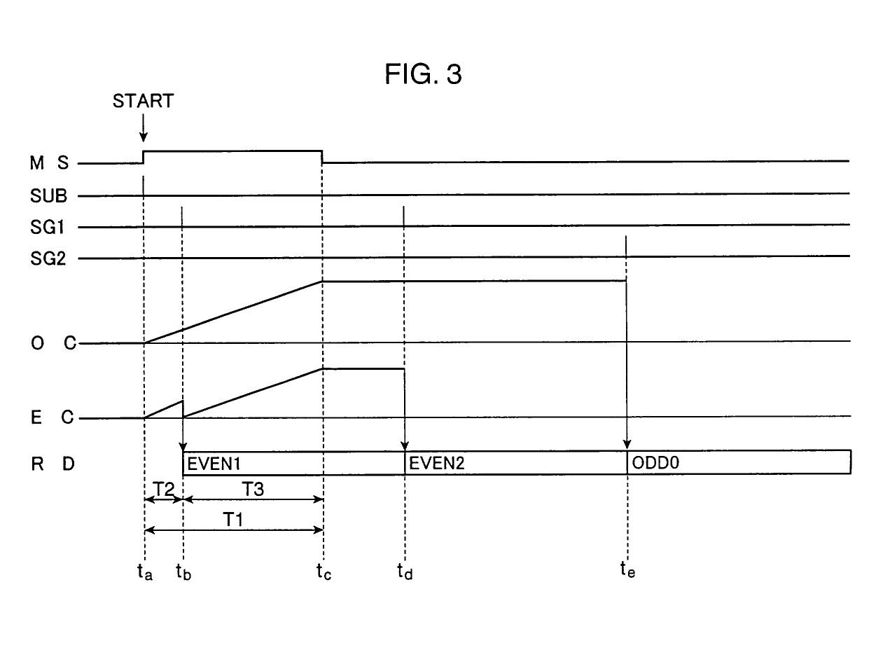

The light measuring device 10 performs a light measurement as a photographing preparation when the shutter start button is pressed halfway and sets a proper aperture value and a proper exposure period based on the obtained light measurement value. It should be noted that an exposure period T1 is set as a proper exposure period as shown in FIG. 3 described later in the first embodiment, and exposure periods T2, T3 are set based on this exposure period T1.

A power supply for supplying a power to the respective switches and the respective parts is not shown. It should be noted that the respective parts and devices of the electronic camera are formed by a CPU, a ROM, a RAM, or the like if necessary.

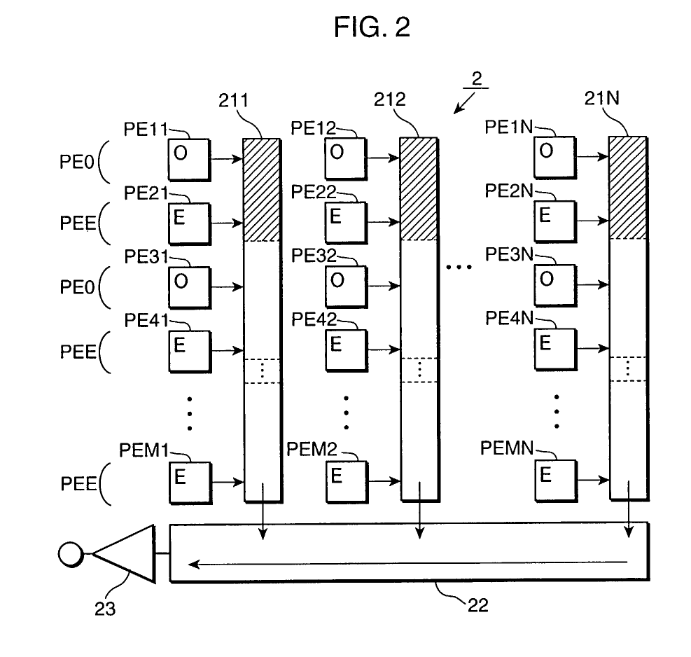

Here, the CCD sensor 2 is described in detail. FIG. 2 is a block diagram showing the construction of the CCD sensor 2. The CCD sensor 2 includes a plurality of light sensing elements PE_{i.j} (i=1 to M, j=1 to N), a plurality of vertical transferring devices 211 to 21N, a horizontal transferring device 22 and an output device 23.

The light sensing elements PE_{i.j} form a first light sensor PEO comprised of groups of light sensing elements PE_{i.j} (i=odd number of 1 to M, j=1 to N) of every other lines, each group consisting of the light sensing elements of one line, and a second light sensor PEE comprised of groups of light sensing elements PE_{i.j} (i=even number of 1 to M, j=1 to N) other than those of the first light sensor PEO.

The respective light sensing elements PE_{i.j} are formed of photodiodes and adapted to photoelectrically convert lights incident thereon during an exposure period and transfer signal charges accumulated according to amounts of the incident lights to the vertical transferring devices 211 to 21N at once.

Each of vertical transferring devices 211 to 21N has an ability of transferring the received signal charges of one light sensing element to a hatched portion or a white portion in FIG. 2. In other words, each of the vertical transferring devices 211 to 21N can transfer the signal charges of (M/2) light sensing elements (here, M denotes the number of the lines of the light sensing elements PE_{i.j}) to the horizontal transferring device 22nsferring device 22.

The respective vertical transferring devices 211 to 21N serially transfer the transferred signal charges to the horizontal transferring device 22, which in turn serially transfers the transferred signal charges to the output device 23. The output device 23 outputs an image signal corresponding to the transferred signal charges.

Next, the operation of the CCD sensor 2 constructed as above is described. The signal charges accumulated in the respective light sensing elements PE_{i.j} (i=odd number of 1 to M, j=1 to N) arrayed in the first light sensor PEO are transferred in parallel to the vertical transferring devices 211 to 21N, which then successively transfer the signal charges line by line to the horizontal transferring device 22. Subsequently, the transferred signal charges are successively transferred line by line from the horizontal transferring device 22 to the output device 23, which in turn outputs them as the image data ODD0 of the odd-numbered lines to be described later pixel by pixel.

At timings different from the transferring timings of the signal charges accumulated in the respective light sensing elements PE_{i.j} (i=odd number of 1 to M, j=1 to N) arrayed in the first light sensor PEO, the signal charges accumulated in the respective light sensing elements PE_{i.j} (i=even number of 1 to M, J=1 to N) arrayed in the second light sensor PEE are similarly transferred to the output device 23 via the vertical transferring devices 211 to 21N and the horizontal transferring device 22, and the output device 23 outputs them as first image data EVEN1 and second image data EVEN2 of the even-numbered lines to be described later pixel by pixel.

As described above, the image data ODD0, EVEN1 and EVEN2 are the image signals corresponding to the signal charges from the groups of the light sensing elements of one line, the groups recurring every other lines. An other CCD sensor or the like can be used as the CCD sensor 2 provided that it can perform the operation as described above. For example, a frame interline transfer type CCD sensor and the like may be used.

Next, the operation of the electronic camera thus constructed is described. FIG. 3 is a timing chart showing the operations of the CCD sensor 2 and the timing generator 31 of the electronic camera shown in FIG. 1. It should be noted that a control pulse SUB and shift pulses SG1, SG2 shown in FIG. 3 are signals outputted as control signals SC1 from the timing generator 31 to the CCD sensor 2.

First, when a shutter start button (not shown) is externally pressed down for an exposure, the mechanical shutter 12 is opened to have an aperture corresponding to the set aperture value. In FIG. 3, a signal for opening and closing the mechanical shutter 12 is shown as a mechanical shutter signal MS, wherein low level of the mechanical shutter signal SM represents the closed state of the mechanical shutter 12 while high level thereof represents the opened state of the mechanical shutter 12.

In the above state, the timing generator 31 generates the control pulse SUB at time tₐ in order to precisely control the set exposure period. The electric charges residual in the first and second light sensors PEO and PEE of the CCD sensor 2, i.e., in all the light sensing elements PE_{i.j} are discharged (initialized) in response to the generated control pulse SUB. Synchronously with the control pulse SUB, the level of the mechanical shutter signal MS is changed from LOW to HIGH. Accordingly, exposures to the first and second light sensors PEO, PEE are started with time tₐ as starting points of exposure periods T1, T2, whereupon signal charges OC accumulated in the respective light sensing elements PE_{i.j} (i=odd number of 1 to M, j=1 to N) forming the first light sensor PEO and signal charges EC accumulated in the respective light sensing elements PE_{i.j} (i=even number of 1 to M, j=1 to N) forming the second light sensor PEE increase with time.

Subsequently, the timing generator 31 generates the shift pulse SG1 at time t_{b} reached upon the elapse of the exposure period T2. In accordance with the generated shift pulse SG1, the signal charges of the respective light sensing elements PE_{i.j} forming the second light sensor PEE are transferred to the vertical transferring devices 211 to 21N, the vertical transferring devices 211 to 21N transfer them line by line to the horizontal transferring device 22, and a first image signal EVEN1 is read. As a result, a first image signal EVEN1 of the second light sensor PEE is outputted as an image signal RD to be outputted from the output device 23. Simultaneously, a new exposure is started to the second light sensor PEE at time t_{b}.

Subsequently, when the level of the mechanical shutter signal MS is changed from HIGH (opened state) to LOW (closed state) and the mechanical shutter 12 is closed at time t_{c} reached upon the elapse of the exposure period T3, the exposures to the first and second light sensors PEO, PEE are completed, and the signal charges of the respective light sensing elements PE_{i.j} of the second light sensor PEE become the signal charges accumulated during the exposure period T3, whereas the signal charges of the respective light sensing elements PE_{i.j} of the first light sensor PEO become the signal charges accumulated during the exposure period T1.

At time t_{d} when the readout of the first image signal EVEN1 of the second light sensor PEE is completed, the timing generator 31 generates the shift pulse SG1. In accordance with the generated shift pulse SG1, the signal charges EC of the respective light sensing elements PE_{i.j} forming the second light sensor PEE are transferred to the vertical transferring devices 211 to 21N, the vertical transferring devices 211 to 21N transfer them line by line to the horizontal transferring device 22, and a second image signal EVEN2 is read. As a result, a second image signal EVEN2 of the second light sensor PEE is outputted as the image signal RD to be outputted from the output device 23.

Subsequently, at time t_{c} when the readout of the second image signal EVEN2 of the second light sensor PEE is completed, the timing generator 31 generates the shift pulse SG2. In accordance with the generated shift pulse SG2, the signal charges OC of the respective light sensing elements PE_{i.j} forming the first light sensor PEO are transferred to the vertical transferring devices 211 to 21N, the vertical transferring devices 211 to 21N transfer them line by line to the horizontal transferring device 22, and an image signal ODD0 is read. As a result, the image signal ODD0 of the first light sensor PEO is outputted as the image signal RD to be outputted from the output device 23.

In the first embodiment, since the exposure period T2 is set at ¼ of the exposure period T1, the first image signal EVEN1 of the even-numbered lines generated during the exposure period T2 can be made four times more unlikely to saturate than the image signal ODD0 of the odd-numbered lines generated during the exposure period T1. Further, since the exposure period T3 is set at almost ¾ of the exposure period T1, the second image signal EVEN2 of the even-numbered lines can have a sensitivity higher (higher S/N ratio) than that of the first image signal EVEN1 of the even-numbered lines.

The exposure periods T2, T3 are defined by dividing the exposure period T1. If the pulse duration of the shift pulse SG1 is sufficiently short to be negligible, T1=T2+T3, which means temporal overlapping of the exposure period T1 of the first light sensor PEO and the exposure periods T2, T3 of the second light sensor PEE. Accordingly, the first and second image signals EVEN1, EVEN2 of the second light sensor PEE and the image signal ODD0 of the first light sensor PEO are image signals substantially simultaneously obtained by photographing. Therefore, the first and second image signals EVEN1, EVEN2 of the second light sensor PEE can be made into image signals representing images which have positional agreement with an image represented by the image signal ODD0 of the odd-numbered lines.

Further, the second image signal EVEN2 of the second light sensor PEE is read after the first image signal EVEN1 of the second light sensor PEE is read, and the image signal ODD0 of the first light sensor PEO is read after the second image signal EVEN2 of the second light sensor PEE is read. Since the respective image signals are read according to the duration of the exposure periods: the shorter the exposure period, the earlier the signal is read, the influence of noise generated during a period between the completion of the exposure and the start of the readout can be reduced.

Since the exposure period T2 is controlled based on the electronic shutter operation by the CCD sensor 2, the shortest exposure period T2 can be precisely controlled. Further, since the terminus ends of the exposure periods T1, T3 are controlled based on the mechanical shutter operation of the mechanical shutter 12, the lights incident on the first and second light sensors PEO, PEE can be blocked by simultaneously terminating the exposure periods T1, T3, with the result that the first and second image signals EVEN1, EVEN2 of the second light sensor PEE and the image signal ODD0 of the first light sensor PEO can be successively read while ensuring sufficient readout times.

A ratio of the exposure periods T2 to T3 is not particularly restricted to the above example and can take various values. In consideration of the S/N ratio and the like of the first image signal EVEN1 having a short exposure period, this ratio is preferably 1:1 to 1:8. Further, the ratio of the exposure periods T2 to T3 may be so set as make the exposure period T3 shorter than the exposure period T2.

After correlative double sampling is applied to the thus read first and second image signals EVEN1, EVEN2 of the second light sensor PEE and image signal ODD0 of the first light sensor PEO by the signal processor 32, these signals are converted into, for example, digital data of 10 bits, which are then outputted as first and second image data EVEN1, EVEN2 of the second light sensor PEE and an image data ODD0 of the first light sensor PEO.

Subsequently, the first image data EVEN1 of the even-numbered lines of 10 bits is saved in the Afield memory 41 of the memory 4; the second image data EVEN2 of the even-numbered lines of 10 bits is saved in the B-field memory 42 of the memory 4; and the image data ODD0 of the odd-numbered lines of 10 bits is saved in the C-field memory 43 of the memory 4.

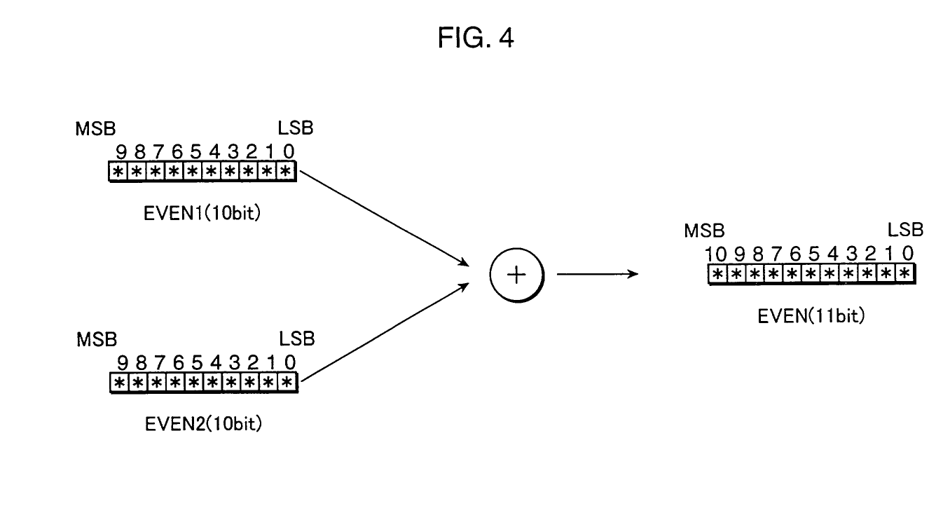

As shown in FIG. 4, the first image data EVEN1 of the even-numbered lines of 10 bits and the second image data EVEN2 of the even-numbered lines of 10 bits are added by the adding device 50 to generate an image data EVEN of the even-numbered lines of 11 bits.

In this way, the first image data EVEN1 of the even-numbered lines which is unlikely to saturate although having a low sensitivity (low S/N ratio) and the second image data EVEN2 of the even-numbered lines having a normal sensitivity are added. Thus, the image data EVEN of the even-numbered lines can be made more unlikely to saturate than the image signal ODD0 of the odd-numbered lines having a high sensitivity, and the S/N ratio of the image data EVEN of the even-numbered lines can be improved.

On the other hand, the image data ODD0 of the odd-numbered lines of 10 bits is converted into an image data ODD of the odd-numbered lines of 11 bits by the bit converting device 51. For example, if a data 1023 is inputted as an upper limit, it is outputted after being converted into a data 2047 as an upper limit.

Further, the white compression detecting device 52 judges whether or not the image data ODD0 of the odd-numbered lines of 10 bits is saturated, i.e., the value of this image data is sufficiently close to 1023. Specifically, if the value of a portion of this data is 1000 or larger, this portion is detected as a white compression portion.

In the case that the white compression portion is detected by the white compression detecting device 52, an image data obtained by interpolation using the image data EVEN of the even-numbered lines of 11 bits is outputted as an image data ODD of the odd-numbered lines of 11 bits from the white compression correcting device 53 to the image data combining device 54 instead of the image data ODD of the odd-numbered lines of 11 bits in which the white compression has occurred. On the other hand, in the case that no white compression portion is detected, the image data ODD of the odd-numbered lines of 11 bits is outputted as it is to the image data combining device 54.

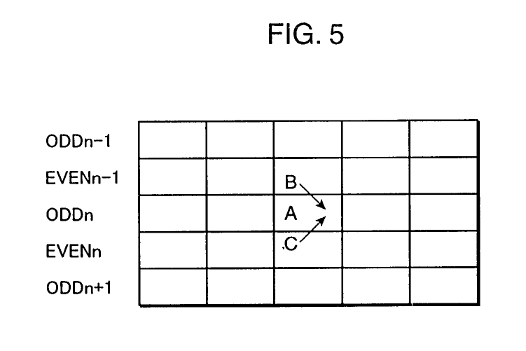

For example, as shown in FIG. 5, if the white compression detecting device 52 detects a white compression portion in an image data (image data ODD0 of the odd-numbered line of 10 bits) of a pixel A on an odd-numbered line ODDn, the image data of the pixel A is interpolated by adding an image data (image data EVEN of the even-numbered line of 11 bits) of a pixel B on an even-numbered line EVENn-1 located above the pixel A and an image data (image data EVEN of the even-numbered line of 11 bits) located below the pixel A and dividing the obtained sum by 2.

Subsequently, the image data ODD of the odd-numbered line of 11 bits outputted from the white compression correcting device 53 and the image data EVEN of the even-numbered line of 11 bits outputted from the adding device 50 are combined in the image combining device 54, thereby generating the image data of the entire screen of 11 bits.

Then, the γ-correction applying device 56 applies a specified γ-correction to the image data to convert this image data into an image data having a desired γ-characteristic, and the resulting data is saved as a subject image data in the memory 8.

The image data corrected by the γ-correction applying device 56 is compressed by the image data compressing device 58 and stored in the recording medium 91. In the case that the image data stored in the recording medium 91 is displayed as an image on the display device 72, it is read and expanded by the image data expanding device 59 and outputted to the display device 72.

In this way, the dynamic range can be extended while an image having a good image quality can be obtained, using the first image data EVEN1 of the even-numbered lines which is unlikely to saturate although having a low sensitivity (low S/N ratio), the second image data EVEN2 of the even-numbered lines which compensates for the low sensitivity, and the image data ODD0 of the odd-numbered lines having a usual sensitivity, which image data were obtained by photographing conducted at overlapping timings, i.e., substantially simultaneously.

Specifically, in the first embodiment, the first image data EVEN1 of the even-numbered lines is made four times more unlikely to saturate than the image signal ODD0 of the odd-numbered lines by setting the exposure period T2 at ¼ of the exposure period T1, and the second image signal EVEN2 of the even-numbered lines is made to have a higher sensitivity (higher S/N ratio) than the first image signal EVEN1 of the even-numbered lines by setting the exposure period T3 at about ¾ of the exposure period T1. Thus, the image data EVEN of the even-numbered lines generated by adding the first and second image data EVEN1, EVEN2 of the even-numbered lines can be made more unlikely to saturate than the image data ODD of the odd-numbered lines, and is enabled to have an improved S/N ratio.

Further, the exposure period T1 and the exposure periods T2, T3 temporally overlap and the first and second image signals EVEN1, EVEN2 of the even-numbered lines and, accordingly, the image signal ODD0 of the odd-numbered lines are image signals obtained by photographing substantially simultaneously conducted. Thus, the image data EVEN of the even-numbered lines representing an image which has positional agreement with the one represented by the image data ODD of the odd-numbered lines can be obtained.

Since the white compression portion is interpolated using the image data EVEN of the even-numbered lines which are more unlikely to saturate and blur-free and have a high S/N ratio as described above, the dynamic range can be extended and still images having a good image quality can be obtained.

Although the two exposure periods are defined for the even-numbered lines by dividing the exposure period of the light sensing elements of the odd-numbered lines into two in the first embodiment, two exposure periods may be defined for the odd-numbered lines by diving the exposure period of the light sensing elements of the even-numbered lines into two and a white compression portion of the image signal of the even-numbered line may be interpolated using image signals of the odd-numbered lines. Further, although the exposure period is divided into two in the first embodiment, the present invention is not particularly limited thereto. For example, the exposure period may be divided into three or more.

Although a case where the blank-and-white image data are generated is described in the first embodiment, the present invention may be applied to generation of color image data. In such a case, a color filter 13 having a specified color array is provided on the front side of the CCD sensor 2; a white balance (WB) adjusting device 55 for adjusting a white balance for the respective colors is provided between the image data combining device 54 and the γ-correction applying device 56; and a color-difference matrix processing device 57 for converting the signals of the respective colors into specified luminance signals and color-difference signals and outputting the converted signals to the display device 72 is provided between the memory 8 and the image data compressing device 58.

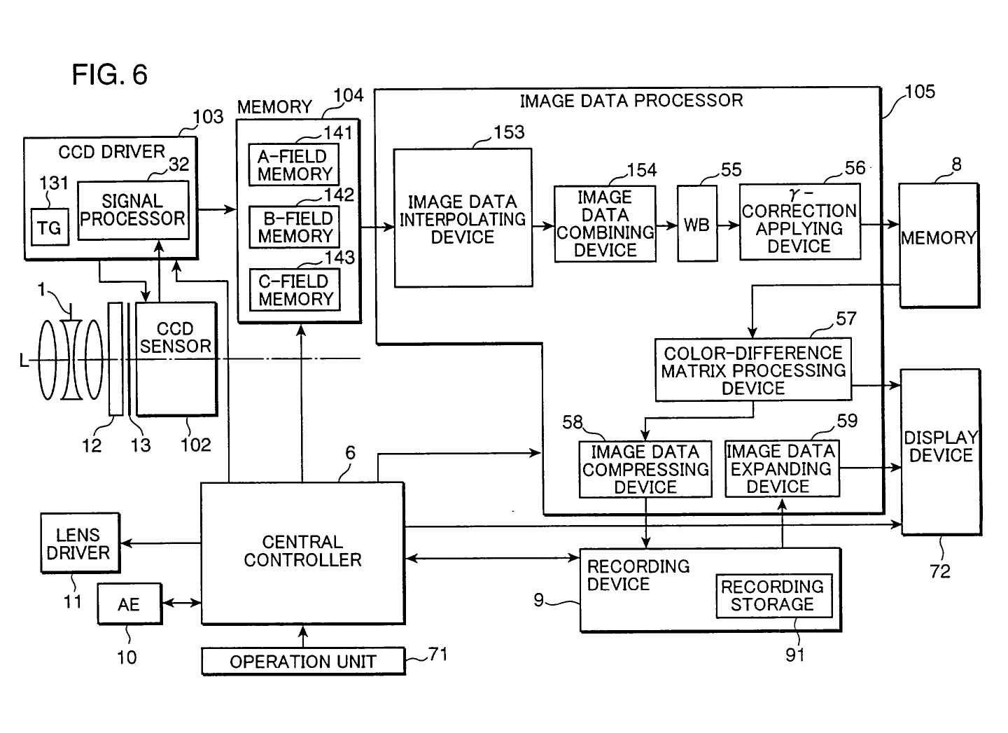

Next, an electronic camera according to another embodiment of the present invention is described with reference to FIGS. 6 to 11. It should be noted that no description is given on the same elements as those shown in FIGS. 1 to 5 by identifying them by the same reference numerals.

Referring to FIG. 6, an electronic camera shown is provided with a taking lens 1, a CCD sensor 102, a CCD driver 103, a memory 104, an image data processor 105, a central controller 6, an operation unit 71, a display device 72, a memory 8 and a recording device 9. It should be noted that a color filter 13 having a specified color array is provided on the front surface or side toward a subject of the CCD sensor 102.

Here, the color filter 13 is a primary color filter having a Bayer color array.

The CCD sensor 102 is constructed such that a multitude of light sensing elements PE_{i.j} (i=1 to M, j=1 to N)are arrayed in a matrix, lights from a subject are photoelectrically converted by the respective light sensing elements, and the converted electric charges are accumulated. The CCD sensor 102 is, for example, an interline-transfer type CCD sensor in which light sensing elements made of photodiodes are arrayed in a matrix.

The CCD driver 103 drives the CCD sensor 102 and includes a timing generator 131 and a signal processor 32.

The timing generator 131 outputs a control signal SC101 to be described later to the CCD sensor 102. The CCD sensor 102 performs a specified operation such as a release of residual electric charges in response to the control signal SC101, photoelectrically converts an incident light, and outputs the accumulated electric charges to the signal processor 32 as an image signal.

The memory 104 is adapted to temporarily save the image signal obtained by the CCD sensor 102 and includes three field memories 141 to 143. Out of the image data outputted from the signal processor 32, an image of A-field to be described later is saved in an A-field memory 141; an image of B-field to be described later is saved in a B-field memory 142; and an image of C-field to be described later is saved in the C-field memory 143.

The image data processor 105 applies specified processings to the image signals saved in the memory 104, and includes an image data interpolating device 153, an image data combining device 154, a white balance (WB) adjusting device 55, a γ-correction applying device 56, a color-difference matrix processing device 57, an image data compressing device 58, and an image data expanding device 59.

The image data interpolating device 153 reads the respective image data saved in the A, B and C-field memories 141, 142, 143 of the memory 104, applies a specified interpolation thereto, and outputs the resulting image data to the image data combining device 154.

The image combining device 154 generates one image data by combining the three image data interpolated by the image data interpolating device 153 and outputs it to the WB adjusting device 55.

The WB adjusting device 55 adjusts the white balance of the image data obtained by the image data combining device 54 for each of three primary colors of R (red), G (green) and B (blue).

The color-difference matrix processing device 57 converts the signals of the respective colors of R, G, B included in the image data or subject image data to which the γ-correction was applied by the γ-correction applying device 56 into specified luminance signals and color-difference signals, and outputs them to the display device 72 and the like.

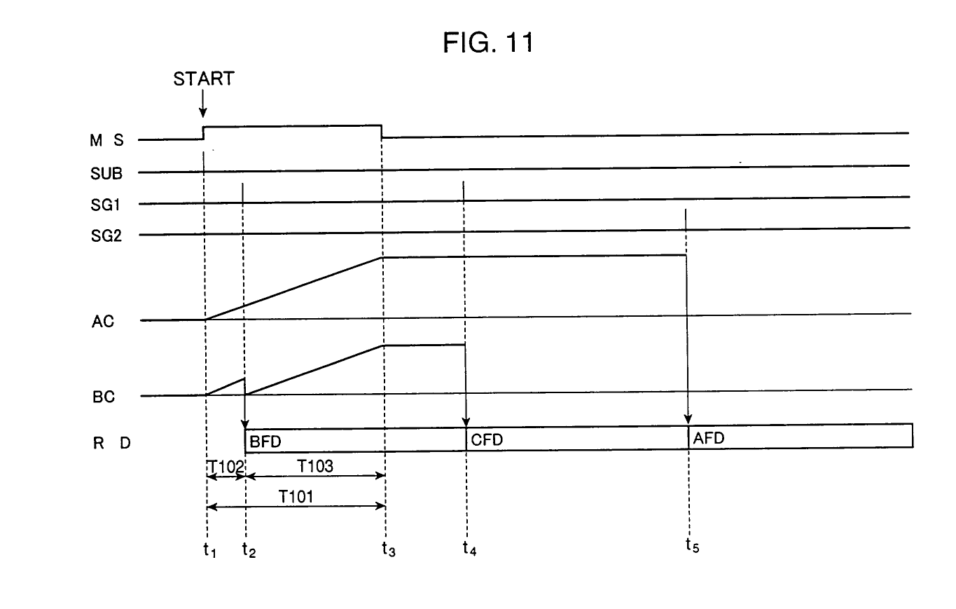

In the second embodiment, an exposure period T102 is set at a proper exposure period as shown in FIG. 11 to be described later, and exposure periods T101, T103 are set based on this exposure period T102.

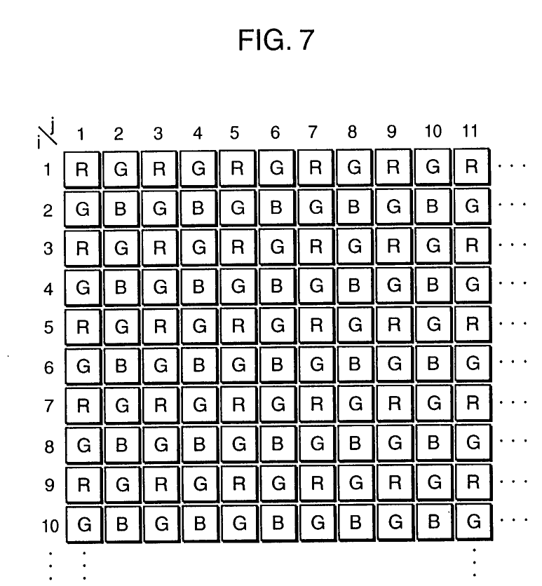

Next, the color filter 13 is described in detail. FIG. 7 is a diagram showing the color filter 13. As shown in FIG. 7, green (G) filters having a large contribution to the luminance signals which require a high resolution are first arrayed in a checkered pattern, and red (R) and blue (B) filters are arrayed in a checkered pattern in a remaining area. The filters of the respective colors are arrayed at positions corresponding to the light sensing elements PE_{i.j} of the CCD sensor 102 (or integrally formed with the light sensing elements PE_{i.j} of the CCD sensor 102).

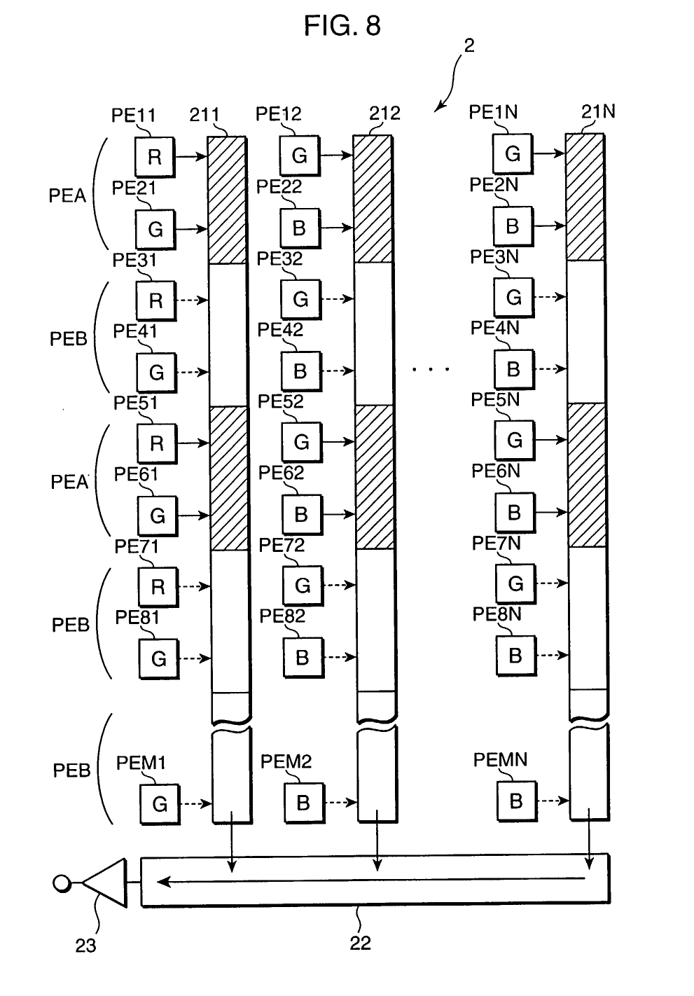

Here, the CCD sensor 102 is described in detail. FIG. 8 is a block diagram showing a construction of the CCD sensor 102. The CCD sensor 102 includes the light sensing elements PE_{i.j}, vertical transferring devices 211 to 21N, a horizontal transferring device 22 and an output device 23.

The light sensing elements PE_{i.j} form a first light sensor PEA comprised of groups of the light sensing elements PE_{i.j} (i=multiple of 4 +(1 or 2), j=1 to N) of consecutive two ones, the groups recurring at the intervals of four lines, and a second light sensor PEB comprised of groups of the light sensing elements PE_{i.j} (i=multiple of 4 +(3 or 0), j=1 to N) other than those of the first light sensor PEA.

The respective light sensing elements PE_{i.j} are formed of photodiodes and adapted to photoelectrically convert lights incident thereon during an exposure period and transfer signal charges accumulated according to amounts of the incident lights to the vertical transferring devices 211 to 21N at once.

Each of vertical transferring devices 211 to 21N has an ability of transferring the received signal charges of one light sensing element to a hatched portion or a white portion in FIG. 2. In other words, each of the vertical transferring devices 211 to 21N can transfer the signal charges of (M/2) light sensing elements (here, M denotes the number of the lines of the light sensing elements PE_{i.j}) to the horizontal transferring device 22.

The respective vertical transferring devices 211 to 21N serially transfer the transferred signal charges to the horizontal transferring device 22, which in turn serially transfers the transferred signal charges to the output device 23. The output device 23 outputs an image signal corresponding to the transferred signal charges.

Next, the operation of the CCD sensor 102 constructed as above is described. The signal charges accumulated in the respective light sensing elements PE_{i.j} (i=multiple of 4 +(1 or 2), j=1 to N) arrayed in the first light sensor PEA are transferred in parallel to the vertical transferring devices 211 to 21N, which then successively transfer the signal charges in units of two lines to the horizontal transferring device 22. Subsequently, the transferred signal charges are successively transferred in units of two lines from the horizontal transferring device 22 to the output device 23, which in turn outputs them pixel by pixel as an image signal of A-field to be described later (corresponding to the first image signal).

Next, a method for transferring the signal charges from the respective light sensing elements PE_{i.j} to the vertical transferring devices 211 to 21N is described in detail. Here, only the vertical transferring device 211 is described for the sake of convenience.

First, in response to a shift pulse SG1a from the timing generator 131, the signal charges of the light sensing elements PE_{i.j} (i=multiple of 4 +1) corresponding to the red filters out of those of the first light sensor PEA are transferred to the vertical transferring device 211 (hatched portion in FIG. 8). Subsequently, in response to a vertical transfer pulse SG1b from the timing generator 131, the signal charges already transferred to the vertical transferring device 211 are shifted from the hatched portion to the white portion in FIG. 8 or downward of FIG. 8 toward the horizontal transferring device 22 by one light sensing element.

Then, in response to a shift pulse SG1c from the timing generator 131, the signal charges of the light sensing elements PE_{i.j} (i=multiple of 4 +2) corresponding to the green filters out of those of the first light sensor PEA are transferred to the vertical transferring device 211 (hatched portion in FIG. 8). In this way, the signal charges of the light sensing elements PE_{i.j} (i=multiple of 4 +1, j =1 to N) corresponding to the red filters of the first light sensor PEA and the signal charges of the light sensing elements PE_{i.j} (i=multiple of 4 +2, j =1 to N) corresponding to the green filters of the first light sensor PEA are alternately arrayed in the vertical transferring device 211.

Subsequently, the signal charges of two lines of the light sensing elements PE_{i.j} (i=multiple of 4 +1) and the light sensing elements PE_{i.j} (i=multiple of 4 +2) are successively transferred to the horizontal transferring device 22 by the vertical transferring devices 211 to 21N.

It should be noted that a shift pulse SG1 (see FIG. 11) to be described later is a collection of the shift pulse SG1a, the vertical transfer pulse SG1b and the shift pulse SG1c.

At timings different from the transferring timings of the signal charges accumulated in the respective light sensing elements PE_{i.j} (i=multiple of 4 +(1 or 2), j=1 to N) arrayed in the first light sensor PEA, the signal charges accumulated in the respective light sensing elements PE_{i.j} (i=multiple of 4 +(3 or 0), j=1 to N) arrayed in the second light sensor PEB are similarly transferred to the output device 23 via the vertical transferring devices 211 to 21N and the horizontal transferring device 22 as above, and the output device 23 outputs them as an image signal of B or C-field to be described later pixel by pixel.

As described above, the image signals of A, B and C-fields are image signals corresponding to the signal charges from the groups of the light sensing elements of two consecutive lines, the groups recurring at intervals of four lines. CCD sensors of other kinds may be used as the CCD sensor 2 provided that they can operate as above.

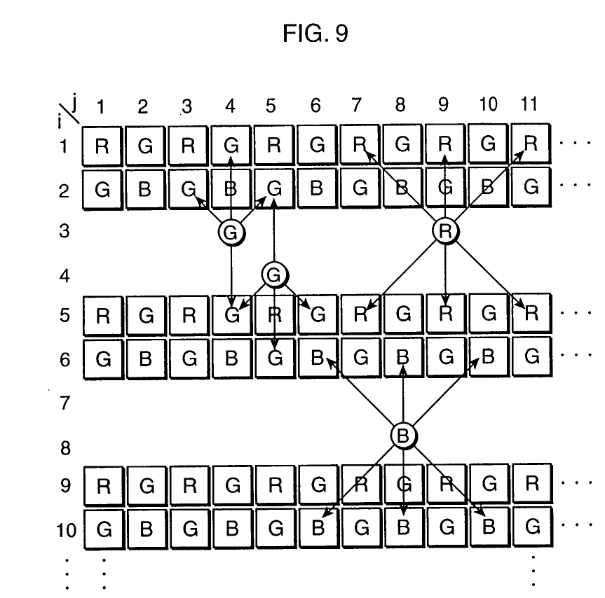

An interpolating operation by the image data interpolating device 153 is described with reference to FIG. 9 for a case where the image signal of A-field is interpolated. Specifically, there is described a case where image signals corresponding to the signal charges from the first light sensor PEA which is the groups of the light sensing elements of two consecutive lines, the groups recurring at the intervals of four lines, are used to interpolate an image signal corresponding to the second light sensor PEB which are groups of the light sensing elements other than those of the first light sensor PEA. Here, image signals QE_{i.j} (i=1 to M, j=1 to N) are assumed to be image signals corresponding to signal charges of the light sensing elements PE_{i.j} (i=1 to M, j=1 to N)

Out of the image signals QE_{i.j} (i=multiple of 4+(3 or 0), j=1 to N) corresponding to the second light sensor PEB, the images signals QE_{i.j} at the target positions corresponding to the red and blue filters of the color filter 13 are interpolated using six image signals QE_{i.j} around and closer to the target positions. Specifically, the image signal QE_{i.j} is interpolated using following equation (1):

QE_{i.j}=(QE_{i-2, j-2}+QE_{i-2, j}+QE_{i-2, j+2}+QE_{i+2, j-2 +}QE_{i+2, j}+QE_{i+2, j+2} ) /6 . . . (1)

Out of the image signals QE_{i.j} (i=multiple of 4+(3 or 0), j=1 to N) corresponding to the second light sensor PEB, the images signals QE_{i.j} at the target positions corresponding to the green filters of the color filter 13 are interpolated using four image signals QE_{i.j} around and closer to the target positions. Specifically, the image signal QE_{i.j} is interpolated using following equation (2) or (3):

QE_{i.j}=(QE_{i-1, j-1}+QE_{i-1, j+1}+QE_{i-2, j}+QE_{i+2,j})/4 . . . (2)

QE_{i.j}=(QE_{i+1, j-1}+QE_{i+1, j+1}+QE_{i-2, j+QE}_{i+2, j})/4 . . . (3)

Interpolation is applied to the image signals of B and C-fields by a similar method. Although the respective image signals QE_{i.j} are interpolated by being merely averaged in this embodiment, other methods may be used for interpolation. For example, weighted average may be obtained using preset weights for interpolation. Further, in this embodiment, the image signals QE_{i.j} at the target positions corresponding to the red and blue filters of the color filter 13 are interpolated using six image signals QE_{i.j} around and closer to the target positions and the image signals QE_{i.j} at the target positions corresponding to the green filters of the color filter 13 are interpolated using four image signals QE_{i.j} around and closer to the target positions. However, the number of the image signals used for interpolation is not restricted to the above and may be suitably selected.

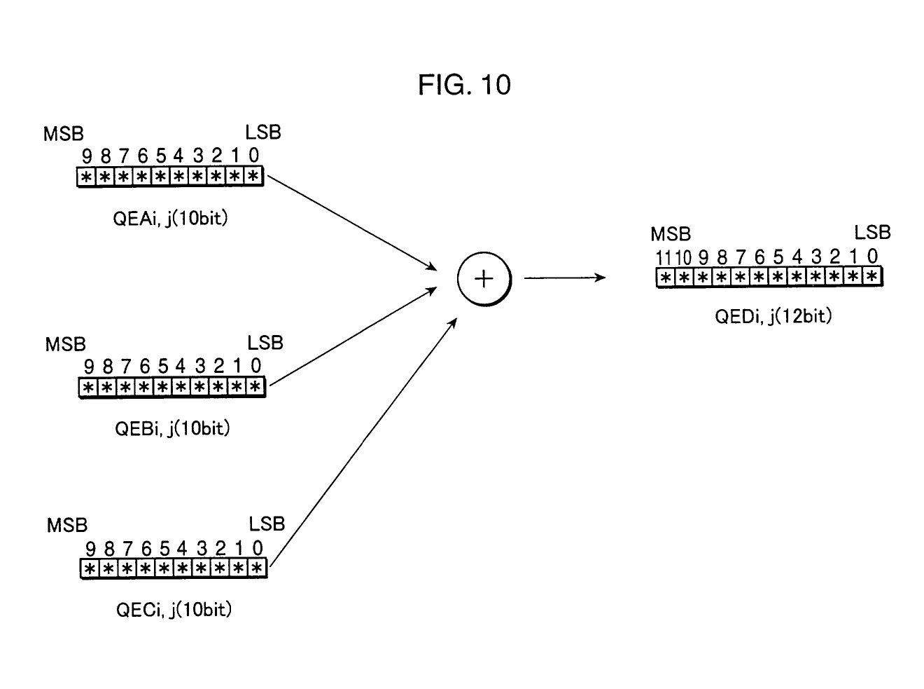

Next, an image data combining operation by the image data combining device 154 is described with reference to FIG. 10. A case where the image data interpolated by the image data interpolating device 153 are 10-bit data for the respective pixels is described. The 10-bit image data QEA_{i.j} obtained by interpolating the image signal of A-field, the 10-bit image data QEB_{i.j} obtained by interpolating the image signal of B-field and the 10-bit image data QEC_{i.j} obtained by interpolating the image signal of C-field are added to obtain 12-bit image data QED_{i.j}. It should be noted that i=1 to M, j=1 to N, and the above operation is performed for each pixel at the corresponding position.

Although the image data obtained by interpolating the image signals of A, B and C-fields are combined by addition in the second embodiment, other methods may be used to combine. For example, a weighted average of the image data obtained by interpolating the image signals of A, B and C-fields may be calculated as a combined image using specified weights.

Next, the operation of the electronic camera thus constructed is described. FIG. 11 is a timing chart showing the operations of the CCD sensor 102 and the timing generator 131 of the electronic camera shown in FIG. 6. It should be noted that a control pulse SUB and shift pulses SG1, SG2 shown in FIG. 11 are signals outputted as control signals SC101 from the timing generator 131 to the CCD sensor 102.

First, when a shutter start button (not shown) is externally pressed down for an exposure, the mechanical shutter 12 is opened to have an aperture corresponding to the set aperture value. In FIG. 11, a signal for opening and closing the mechanical shutter 12 is shown as a mechanical shutter signal MS, wherein low level of the mechanical shutter signal SM represents the closed state of the mechanical shutter 12 while high level thereof represents the opened state of the mechanical shutter 12.

In the above state, the timing generator 131 generates the control pulse SUB at time t₁ in order to precisely control the set exposure period. The electric charges residual in the first and second light sensors PEA and PEB of the CCD sensor 102, i.e., in all the light sensing elements PE_{i.j} are discharged (initialized) in response to the generated control pulse SUB. Synchronously with the control pulse SUB, the level of the mechanical shutter signal MS is changed from LOW to HIGH. Accordingly, exposures to the first and second light sensors PEA, PEB are started with time t₁ as starting points of exposure periods T101, T102, whereupon signal charges AC accumulated in the respective light sensing elements PE_{i.j} (i=multiple of 4 +(1 or 2), j=1 to N) forming the first light sensor PEA and signal charges BC accumulated in the respective light sensing elements PE_{i.j} (i=multiple of 4 +(3 or 0), j=1 to N) forming the second light sensor PEB increase with time (electric charges are accumulated).

Subsequently, the timing generator 131 generates the shift pulse SG1 at time t₂ reached upon the elapse of the exposure period T102. In accordance with the generated shift pulse SG1, the signal charges of the respective light sensing elements PE_{i.j} forming the second light sensor PEB of the CCD sensor 102 are transferred to the vertical transferring devices 211 to 21N, the vertical transferring devices 211 to 21N transfer them in units of two lines to the horizontal transferring device 22, and a first image signal BFD (image signal of B-field) is read. As a result, the first image signal BFD of the second light sensor PEB is outputted as an image signal RD to be outputted from the output device 23. Simultaneously, a new exposure is started to the second light sensor PEB at time t₂.

Subsequently, when the level of the mechanical shutter signal MS is changed from HIGH (opened state) to LOW (closed state) and the mechanical shutter 12 is closed at time t₃ reached upon the elapse of the exposure period T103, the exposures to the first and second light sensors PEA, PEB are completed, and the signal charges of the respective light sensing elements PE_{i.j} of the second light sensor PEB become the signal charges accumulated during the exposure period T103, whereas the signal charges of the respective light sensing elements PE_{i.j} of the first light sensor PEA become the signal charges accumulated during the exposure period T101.

At time t₄ when the readout of the first image signal BFD of the second light sensor PEB is completed, the timing generator 131 generates the shift pulse SG1. In accordance with the generated shift pulse SG1, the signal charges BC of the respective light sensing elements PE_{i.j} forming the second light sensor PEB of the CCD sensor 102 are transferred to the vertical transferring devices 211 to 21N, the vertical transferring devices 211 to 21N transfer them in units of two lines to the horizontal transferring device 22, and a second image signal CFD is read. As a result, a second image signal CFD (image signal of C-field) of the second light sensor PEB is outputted as the image signal RD to be outputted from the output device 23.

Subsequently, at time t₅ when the readout of the second image signal CFD of the second light sensor PEB is completed, the timing generator 131 generates the shift pulse SG2. In accordance with the generated shift pulse SG2, the signal charges AC of the respective light sensing elements PE_{i.j} forming the first light sensor PEA of the CCD sensor 102 are transferred to the vertical transferring devices 211 to 21N, the vertical transferring devices 211 to 21N transfer them in units of two lines to the horizontal transferring device 22, and an image signal AFD (image signal of A-field) is read. As a result, the image signal AFD of the first light sensor PEA is outputted as the image signal RD to be outputted from the output device 23.

In this embodiment, it is assumed that the exposure period T102 is set at half the proper exposure period and the exposure period T103 is set at as long as the proper exposure period beforehand (as a result, the exposure period T101 is set at about 1.5 times as long as the proper exposure period). Thus, the first image signal BFD of the second light sensor PEB generated during the exposure period T102 can be made about three times more unlikely to saturate than the image signal AFD of the first light sensor PEA generated during the exposure period T101.

Further, the exposure periods T102, T103 are defined by dividing the exposure period T101. If the pulse duration of the shift pulse SG1 is sufficiently short to be negligible, T101=T102+T103, which means temporal overlapping of the exposure period T101 of the first light sensor PEA and the exposure periods T102, T103 of the second light sensor PEB. Accordingly, the first and second image signals BFD, CFD of the second light sensor PEB and the image signal AFD of the first light sensor PEA are image signals substantially simultaneously obtained by photographing. Therefore, the first and second image signals BFD, CFD of the second light sensor PEB can be made into image signals representing images which have positional agreement with an image represented by the image signal AFD of the first light sensor PEA.

Further, the second image signal CFD of the second light sensor PEB is read after the first image signal BFD of the second light sensor PEB is read, and the image signal AFD of the first light sensor PEA is read after the second image signal CFD of the second light sensor PEB is read. Since the respective image signals are read according to the duration of the exposure periods: the shorter the exposure period, the earlier the signal is read, the influence of noise generated during a period between the completion of the exposure and the start of the readout can be reduced.

Since the exposure period T102 is controlled based on the electronic shutter operation by the CCD sensor 102, the shortest exposure period T102 can be precisely controlled. Further, since the terminus ends of the exposure periods T101, T103 are controlled based on the mechanical shutter operation of the mechanical shutter 12, the lights incident on the first and second light sensors PEA, PEB can be blocked by simultaneously terminating the exposure periods T101, T103, with the result that the first and second image signals BFD, CFD of the second light sensor PEB and the image signal AFD of the first light sensor PEA can be successively read while ensuring sufficient readout times.

The exposure periods T101, T102 and T103 are not particularly restricted to the above example and can take various values. In order to make a combined image (subject image) signal into an image signal having an extended dynamic range, the exposure periods T102, T103 are preferably about 0.3 to 0.9 times and about 1.0 times as long as the exposure period, respectively. Then, the exposure periods T101, T102 and T103 become suitably different exposure periods centered on the proper exposure period. Further, the exposure periods T102, T103 may be set such that the exposure period T103 is shorter than the exposure period T102. In such a case, a subject image signal prioritizing an exposure timing can be obtained since the image signal generated during the proper exposure period (first image signal BFD of the second light sensor PEB) is an image signal obtained at a timing close to the exposure operation.

After correlative double sampling is applied to the thus read first and second image signals BFD, CFD of the second light sensor PEB and image signal AFD of the first light sensor PEA by the signal processor 32, these signals are converted into, for example, digital data of 10 bits, which are then outputted as first and second image data BFD, CFD of the second light sensor PEB and an image data AFD of the first light sensor PEA.

Subsequently, the image data AFD of the first light sensor PEA of 10 bits is saved in the A-field memory 41 of the memory 104; the first image data BFD of the second light sensor PEB of 10 bits is saved in the B-field memory 42 of the memory 104; and the second image data CFD of the second light sensor PEB of 10 bits is saved in the C-field memory 43 of the memory 4.

Then, the image data interpolating device 153 reads the image data AFD, BFD and CFD from the A-field memory 141, the B-field memory 142 and the C-field memory 143 and applies the interpolating operations thereto to generate three image data corresponding to the entire screen. The image data combining device 154 combines the three generated image data to generate one image data.

Subsequently, the WB adjusting device 55 adjusts the white balance of this image data, and the γ-correction applying device 56 applies a specified γ-correction to the image data to convert it into an image data having a desired γ-characteristic. The resulting image data is saved in the memory 8 as a subject image data.

In the case of outputting the subject image data to the display device 72, the respective color signals of R, G and B included in the subject image data are converted into specified luminance signals and color-difference signals and outputted to the display device 72 by the color-difference matrix processing device 57. The converted luminance signals and color-difference signals are compressed by the image data compressing device 58 and stored in the recording medium 91. Further, in the case of displaying the image data stored in the recording medium 91 on the display device 72, the image data is read, expanded and outputted to the display device 72 by the image data expanding device 59.

In this way, one color image or subject image having an extended dynamic range and a good image quality can be obtained using the first image data BFD of the second light sensor PEB which is unlikely to saturate although having a low sensitivity (low S/N ratio), the second image data CFD of the second light sensor PEB having a normal sensitivity, and the image data AFD of the first light sensor PEA having a high sensitivity (high S/N ratio).

Specifically, since the exposure periods T102, T101 are respectively set at 0.5 times and about 1.5 times as long as the proper exposure periods in the second embodiment, the first image signal BFD of the second light sensor PEB can be made about three times more unlikely to saturate than the image signal AFD of the first light sensor PEA.

Further, since the exposure period T101 and the exposure periods T102, T103 temporally overlap, the first and second image signals BFD, CFD of the second light sensor PEB and the image signal AFD of the first light sensor PEA are image signals obtained by photographing substantially simultaneously conducted. Thus, the first and second image signals BFD, CFD of the second light sensor PEB representing images which have positional agreement with an image represented by the image signal AFD of the first light sensor PEA can be obtained.

Further, since the exposure periods T101, T102 and T103 are about 1.5 times, 0.5 times and 1.0 times as long as the proper exposure period, the first image signal BFD of the second light sensor PEB, the second image signal CFD of the second light sensor PEB and the image signal AFD of the first light sensor PEA are image signals whose exposure periods are suitably differed. Thus, the image signal of the subject generated by combining these three image signals after interpolation becomes an image signal having an extended dynamic range.

The present invention may be alternatively embodied as follows.

(A) Although the first and second light sensors are formed by the groups of light sensing elements of two consecutive lines, the groups recurring at intervals of four lines in the second embodiment, they may be formed by groups of light sensing elements of a plurality of consecutive lines, the groups recurring at the intervals of the same plurality of lines.

(B) Although the image signals of A, B and C-fields are image signals corresponding to the signal charges from the groups of light sensing elements of two consecutive lines, the groups recurring at the intervals of four lines in the second embodiment, it is sufficient that at least the image signals of B-field be image signals corresponding to the signal charges from the groups of light sensing elements of two consecutive lines, the groups recurring at the intervals of four lines. In the other words, the image signals of A and C-fields may be image signals obtained, for example, by the general interlacing readout. In such a case, for example, A′-field may be odd-numbered lines and C′-field may be even-numbered lines. However, in this case, a functional device for allotting the image signals to the image data interpolating device 153 and to the memory 104 needs to be provided between the memory 104 and the image data interpolating device 153.

The function of a signal allotting device is specifically described for a case where the signal allotting device for allotting the image signals is provided between the memory 104 and the image data interpolating device 153. Here, it is assumed that image data REA_{i.j} (i=odd number of 1 to M, j=1 to N), REB_{i.j} (i=multiple of 4 +(3 or 0), j=1 to N), REC_{i.j} (i=even number of 1 to M, j=1 to N) corresponding to image signals of A′, B′ and C′-fields are saved in the A-field memory 141, the B-field memory 142 and the C-field memory 143.

The signal allotting device reads the image data REA_{i.j} (i=multiple of 4 +1, j=1 to N) from the light sensing elements included in the first light sensor PEA out of the image data REA_{i.j} corresponding to the image signals of A′-field and the image data REC_{i.j} (i=multiple of 4+2, j=1 to N) from the light sensing elements included in the first light sensor PEA out of the image data REC_{i.j} corresponding to the image signals of C′-field from the memory 104, and outputs them to the image data interpolating device 153. The image data interpolating device 153 performs an interpolating operation similar to the one of the second embodiment using these image data to generate an image data based on the image signal (first image signal) generated during the exposure period T101 in the first light sensor PEA, which image data is to be supplied to the image data combining device 154.

Further, the signal allotting device reads the image data REB_{i.j} (i=multiple of 4 +(3 or 0), j =1 to N) corresponding to the image signals of B′ (=B) field from the memory 104 and outputs them to the image data interpolating device 153. The image data interpolating device 153 performs an interpolating operation similar to the one of the second embodiment using these image data to generate an image data based on the image signal (second image signal) generated during the exposure period T102 in the second light sensor PEB, which image data is to be supplied to the image data combining device 154.

Further, the signal allotting device reads the image data REA_{i.j} (i=multiple of 4+3, j=1 to N) from the light sensing elements included in the second light sensor PEB out of the image data REA_{i.j} corresponding to the image signals of A′-field and the image data REC_{i.j} (i=multiple of 4+0, j=1 to N) from the light sensing elements included in the second light sensor PEB out of the image data REC_{i.j} corresponding to the image signals of C′-field from the memory 104, and outputs them to the image data interpolating device 153. The image data interpolating device 153 performs an interpolating operation similar to the one of the second embodiment using these image data to generate an image data based on the image signal (third image signal) generated during the exposure period T103 in the second light sensor PEB, which image data is to be supplied to the image data combining device 154.

(C) Although three entire screen image data obtained by interpolating the image signals of A, B and C-fields are combined in the second embodiment, two entire screen image data obtained by interpolating the image signals of A and B-fields may be combined. In such a case, the exposure periods T101 and T102 are preferably set at 1.5 to 2.5 times and about 0.5 times as long as the proper exposure period in order to extend the dynamic range of the combined image signal. This is because the exposure periods T101 and T102 can be suitably differed while being centered on the proper exposure period.

(D) Although three entire screen image data obtained by interpolating the image signals of A, B and C-fields are combined in the second embodiment, the image signal of A-field and an image signal obtained by additive combining the image signals of B and C-fields may be interpolated.

An example of this case is specifically described. An image data DFD (11-bit data) of the second light sensor PEB is generated by additive combining the image signals of B and C-fields, i.e., the first image data BFD (e.g., 10-bit data) and the second image data CFD (e.g., 10-bit data) of the second light sensor PEB. Subsequently, an image data AFD2 of 11 bits is generated by doubling the image signal of A-field, i.e., the image data AFD (e.g., 10-bit data) of the first light sensor PEA. An entire screen image data is obtained by interpolating and combining the image data DFD (11-bit data) of the second light sensor PEB and the image data AFD2 (11-bit data) of the first light sensor PEA.

As described above, an image pickup apparatus comprises: a light sensing unit including a first light sensor having a plurality of light sensing elements provided at specified positions and a second light sensor provided adjacent to the first light sensor and having a group of light sensing elements other than those of the first light sensor; an exposure period setter for setting a first exposure period, and a second exposure period and a third exposure period, the second and third exposure periods being obtained by dividing the first exposure period; an image generator for generating a first image signal from electric charges accumulated in the respective light sensing elements during the first exposure period in the first light sensor, generating a second image signal from electronic charges accumulated in the respective light sensing elements during the second exposure period in the second light sensor, and generating a third image signal from electric charges accumulated in the respective light sensing elements during the third exposure period in the second light sensor; and an image combining device for combining the first, second and third image signals to generate an image signal of a subject.

With the image pickup apparatus thus constructed, the exposure period setter sets the first exposure period and the second and third exposure periods obtained by dividing the first exposure period. The image generator generates the first image signal from the electric charges accumulated in the respective light sensing elements during the first exposure period in the first light sensor having a plurality of light sensing elements provided at the specified positions, the second image signal from the electronic charges accumulated in the respective light sensing elements during the second exposure period in the second light sensor having the light sensing elements other than those of the first light sensor, and the third image signal from the electric charges accumulated in the respective light sensing elements during the third exposure period in the second light sensor. Then, the image combining device combines the first, second and third image signals to generate the image signal of the subject.

At this time, since being defined by dividing the first exposure period, the second and third exposure periods are shorter than the first exposure period. Thus, the second and third image signals are made more unlikely to saturate than the first image signal.

Further, since being defined by dividing the first exposure period, the second and third exposure periods temporally overlap the first exposure period and the first, second and third image signals are image signals substantially simultaneously obtained by photographing. Thus, images represented by the second and third images have positional agreement with an image represented by the first image signal.

Since the image signal of the subject is generated by combining the first, second and third image signals whose exposure periods temporally overlap and differ, an image signal having an extended dynamic range and a good image quality can be obtained.

The first light sensor may include groups of light sensing elements of one line, groups recurring every other lines, or groups of light sensing elements of a plurality of consecutive lines, the groups recurring at intervals of the same plurality of lines. Accordingly, the image signals can be easily read out. For example, in the case that the first light sensor includes the groups of light sensing elements of one line, groups recurring every other lines, image signals can be generated by adopting an interline readout method.

It may be preferable to further provide one signal transferring device for transferring the electric charges accumulated in the respective light sensing elements of the first and second light sensors from the light sensing unit to the image generator.

Since the electric charges accumulated in the respective light sensing elements of the first and second light sensors are transferred from the light sensing unit to the image generator by the one signal transferring device, the construction of the image pickup apparatus can be simplified.

The light sensing unit may be further provided with a color filter on the front surfaces of the light sensing elements and having a specified color array. Accordingly, color image signals can be obtained.

Also, The first light sensor may include groups of light sensing elements of a plurality of consecutive lines, the groups recurring at intervals of the same plurality of lines. The first image signal is generated from the electric charges accumulated in the respective light sensing elements of the first light sensor having the groups of light sensing elements of a plurality of consecutive lines, the groups recurring at intervals of the same plurality of lines, and the second and third image signals are generated from the electric charges accumulated in the respective light sensing elements of the second light sensor having the light sensing elements other than those of the first light sensor. Accordingly, the first, second and third image signals include all three primary (or complementary) colors even in the case that a color image is picked up using a primary color (or complementary color) filter in which colors are arrayed in a specified format (e.g., Bayer's format).

Thus, the image signal of the subject is a color image signal having an extended dynamic range and a good image quality since being generated by combining the first, second and third image signals having different exposure periods and including all the primary (or complementary) colors.

The color array of the color filter may be a Bayer's array. General-purpose color CCDs can be used since the color array of the color filter is a Bayer's array.

It may be appreciated to further provide a detector for detecting a white compression portion of the first image signal. The image combining device generates a fourth image signal by adding the second and third image signals and interpolates the white compression portion using the fourth image signal in the case that the white compression portion of the first image signal is detected by the detector.

The fourth image signal is generated by adding the second and third image signals. This enables the fourth image signal to be easily generated, and make more unlikely to saturate than the first image signal, thereby having its SIN ratio improved. Further, since the white compression portion of the first image signal is interpolated using such a fourth image signal upon being detected, a subject image having a good image quality can be obtained.

The second exposure period may be shorter than the third exposure period. The second exposure period is shortest among the first to third exposure periods since being shorter than the third exposure period. Thus, the second image signal is likely to be sufficiently suppressed to a saturation level or lower in comparison to the first image signal, thereby further extending the dynamic range.

It may be appreciated to make the image combining device generate the first and third image signals after generating the second image signal.

Since the image generator generates the first and third image signals after generating the second image signal, the second image signal having a shortest exposure period and likely to be influenced by noise is generated earliest particularly if the second exposure period is shorter than the third exposure period. Thus, the influence of the noise on the image signal can be reduced.

Further, it may be appreciated to make the image combining device generate the first image signal after generating the third image signal.

Since the image combining device generates the first image signal after generating the third image signal, the image signal having a shorter exposure period and likely to be influenced by noise is generated earlier. Thus, the influence of the noise on the image signal can be reduced.

There may be further provided a mechanical shutter for controlling light incident on the light sensing unit. The exposure period setter sets a terminus end of the second exposure period by an electronic shutter operation and sets terminus ends of the first and third exposure periods by an operation of the mechanical shutter.

The second exposure period can be precisely controlled, and the lights incident on the first and third light sensors can be blocked by simultaneously terminating the first and third exposure periods. Therefore, the first to third image signals can be read out while ensuring a sufficient readout time.

The image combining device may be made to perform a first interpolating operation to interpolate the image signal corresponding to the second light sensor using the first image signal to generate a fourth image signal, a second interpolating operation to interpolate the image signal corresponding to the first light sensor using the second image signal to generate a fifth image signal, and a third interpolating operation to interpolate the image signal corresponding to the first light sensor using the third image signal to generate a sixth image signal, and generates the image signal of the subject by combining the fourth, fifth and sixth image signals.

The second and third image signals represent images which have positional agreement with an image represented by the first image signal. Accordingly, the fifth and sixth image signals generated by interpolation using the second and third image signals represent images which have positional agreement with an image represented by the fourth image signal generated by interpolation using the first image signal.

Thus, the image signal of the subject generated by combining the fourth, fifth and sixth image signals is obtained by combining three image signals having a good image quality and different exposure periods and, therefore, is an image signal having an extended dynamic range and a good image quality.

It may be appreciated that the second. exposure period is 0.3 to 0.9 times as long as a proper exposure period and the third exposure period is about as long as the proper exposure period.

Accordingly, the first, second and third exposure periods are 1.3 to 1.9 times, 0.3 to 0.9 times and 1.0 times as long as the proper exposure period. Thus, the first image signal generated from the electric charges accumulated in the light sensing elements during the first exposure period, the second image signal generated from the electric charges accumulated in the light sensing elements during the second exposure period, and the third image signal generated from the electric charges accumulated in the light sensing elements during the third exposure period are image signals whose exposure periods suitably differ. Therefore, the image signal of the subject generated by combining the first, second and third image signals is an image signal having an extended dynamic range.

The image combining device may be made to perform a first interpolating operation to interpolate the image signal corresponding to the second light sensor using the first image signal to generate a fourth image signal and a second interpolating operation to interpolate the image signal corresponding to the first light sensor using the second image signal to generate a fifth image signal, and generate the image signal of the subject by combining the fourth and fifth image signals.

The second image signal represents an image which has positional agreement with an image represented by the first image signal, the fifth image signal generated by interpolation using the second image signal represents an image which has positional agreement with an image represented by the fourth image signal generated by interpolation using the first image signal. Thus, the image signal of the subject generated by combining the fourth and fifth image signals is obtained by combining two image signals having a good image quality and different exposure periods and, therefore, is an image signal having an extended dynamic range and a good image quality.

An image pickup method comprises the steps of: setting a first exposure period, and a second exposure period and a third exposure period, the second and third exposure periods being obtained by dividing the first exposure period; generating a first image signal from electric charges accumulated in a plurality of light sensing elements provided at specified positions during the first exposure period in a first light sensor, generating a second image signal from electronic charges accumulated in a plurality of light sensing elements other than those of the first light sensor during the second exposure period in a second light sensor provided adjacent to the first light sensor, and generating a third image signal from electric charges accumulated in the light sensing elements during the third exposure period in the second light sensor; and combining the first, second and third image signals to generate an image signal of a subject.

In this method, since being defined by dividing the first exposure period, the second and third exposure periods are shorter than the first exposure period. Thus, the second and third image signals are made more unlikely to saturate than the first image signal. Further, since being defined by dividing the first exposure period, the second and third exposure periods temporally overlap the first exposure period and the first, second and third image signals are image signals substantially simultaneously obtained by photographing. Thus, images represented by the second and third images have positional agreement with an image represented by the first image signal.

Since the image signal of the subject is generated by combining the first, second and third image signals whose exposure periods temporally overlap and differ, an image signals having an extended dynamic range and a good image quality can be obtained.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. An image pickup apparatus, comprising:
a light sensing unit including a first light sensor comprised of a plurality of light sensing elements provided at specified positions and a second light sensor provided adjacent to the first light sensor and comprised of a group of light sensing elements other than those of the first light sensor;
an exposure period setter which sets a first exposure period, and a second exposure period and a third exposure period, the second and third exposure periods being obtained by dividing the first exposure period;
an image generator which generates a first image signal from electric charges accumulated in the respective light sensing elements during the first exposure period in the first light sensor, generates a second image signal from electronic charges accumulated in the respective light sensing elements during the second exposure period in the second light sensor, and generates a third image signal from electric charges accumulated in the respective light sensing elements during the third exposure period in the second light sensor; and
an image combining device which combines the first, second and third image signals to generate an image signal of a subject.

2. An image pickup apparatus according to claim 1, wherein the first light sensor includes groups of light sensing elements of one line, groups recurring every other lines, or groups of light sensing elements of a plurality of consecutive lines, the groups recurring at intervals of the same plurality of lines.

3. An image pickup apparatus according to claim 2, further comprising one signal transferring device which transfers the electric charges accumulated in the respective light sensing elements of the first and second light sensors from the light sensing unit to the image generator.

4. An image pickup apparatus according to claim 1, wherein the light sensing unit further includes a color filter provided on the front surfaces of the light sensing elements and having a specified color array, and the first light sensor includes groups of light sensing elements of a plurality of consecutive lines, the groups recurring at intervals of the same plurality of lines.

5. An image pickup apparatus according to claim 4, wherein the color array of the color filter is a Bayer's array.

6. An image pickup apparatus according to claim 1, further comprising a detector which detects a white compression portion of the first image signal, wherein the image combining device generates a fourth image signal by adding the second and third image signals and interpolates the white compression portion using the fourth image signal in the case that the white compression portion of the first image signal is detected by the detector.

7. An image pickup apparatus according to claim 1, wherein the second exposure period is shorter than the third exposure period.

8. An image pickup apparatus according to claim 1, wherein the image combining device generates the first and third image signals after generating the second image signal.

9. An image pickup apparatus according to claim 8, wherein the image combining device generates the first image signal after generating the third image signal.

10. An image pickup apparatus according to claim 1, further comprising a mechanical shutter which controls light incident on the light sensing unit, wherein the exposure period setter sets a terminus end of the second exposure period by an electronic shutter operation and sets terminus ends of the first and third exposure periods by an operation of the mechanical shutter.

11. An image pickup apparatus according to claim 1, wherein the image combining device performs a first interpolating operation to interpolate the image signal corresponding to the second light sensor using the first image signal to generate a fourth image signal, a second interpolating operation to interpolate the image signal corresponding to the first light sensor using the second image signal to generate a fifth image signal, and a third interpolating operation to interpolate the image signal corresponding to the first light sensor using the third image signal to generate a sixth image signal, and generates the image signal of the subject by combining the fourth, fifth and sixth image signals.

12. An image pickup apparatus according to claim 1, wherein the second exposure period is 0.3 to 0.9 times as long as a proper exposure period and the third exposure period is about as long as the proper exposure period.

13. An image pickup apparatus according to claim 1, wherein the image combining device performs a first interpolating operation to interpolate the image signal corresponding to the second light sensor using the first image signal to generate a fourth image signal and a second interpolating operation to interpolate the image signal corresponding to the first light sensor using the second image signal to generate a fifth image signal, and generates the image signal of the subject by combining the fourth and fifth image signals.

14. A method for picking up an image, comprising the steps of:
setting a first exposure period, and a second exposure period and a third exposure period, the second and third exposure periods being obtained by dividing the first exposure period;
generating a first image signal from electric charges accumulated in a plurality of light sensing elements provided at specified positions during the first exposure period in a first light sensor, generating a second image signal from electronic charges accumulated in a plurality of light sensing elements other than those of the first light sensor during the second exposure period in a second light sensor provided adjacent to the first light sensor, and generating a third image signal from electric charges accumulated in the light sensing elements during the third exposure period in the second light sensor; and
combining the first, second and third image signals to generate an image signal of a subject.
